(19) United States
(12) Patent Application Publication
(10) Pub. No.: US 2013/0138517 A1
(43) Pub. Date: May 30, 2013

(54) METHOD AND SYSTEM FOR INTEGRATING WIRELESS DEVICES WITH EXISTING POINT OF SALE SYSTEMS

(71) Applicants: Sameer Mohamed Khan, Trivandrum (IN); Manesh Sadasivan, Kottayam (IN); Koshy Kottoorazhikathu Varghese, Kollam (IN)

(72) Inventors: Sameer Mohamed Khan, Trivandrum (IN); Manesh Sadasivan, Kottayam (IN); Koshy Kottoorazhikathu Varghese, Kollam (IN)

(73) Assignee: INFOSYS LIMITED, Bangalore (IN)

(21) Appl. No.: 13/307,158

(22) Filed: Nov. 30, 2011

(51) Int. Cl. G06Q 30/00

(52) U.S. Cl. 705/16

(57) ABSTRACT

A method for extending point of sale functionalities of an existing point of sale system is provided. In various embodiments of the present invention, the method comprises the step of building at least one Abstracted Core Register Point of Sale (ACR POS) module from at least one existing point of sale register application. The method further comprises the step of optimizing at least one ACR POS module for extending point of sale functionality to at least one wireless device. Further, the method comprises the step of mapping at least one wireless device to at least one virtual register module and at least one optimized ACR POS module to extend the point of sale functionalities of the existing point of sale system to the mapped wireless device. Furthermore, the method comprises the step of performing one or more point of sale tasks using the mapped wireless device.

### FIELD OF THE INVENTION

The present invention relates generally to a Point of Sale (POS) system. More particularly, the present invention provides a system and method for extending the POS functionalities to wireless devices by integrating wireless devices with existing POS system.

### BACKGROUND OF THE INVENTION

Point of Sale (POS) systems are one of the key systems employed in retail stores across various industry segments. At present, most of the retail outlet shops use stationary register-boxes to perform various POS functions. The advancements in the wireless technologies and usage of wireless devices enable optimization of POS operations by extending the POS functionalities to wireless devices. These wireless devices are being deployed to perform the POS operations away from the current fixed POS desk at retail stores.

Conventionally, various systems and methods exist for extending the POS functionality to wireless devices. For example, existing wireless POS technologies may introduce the mobile channel by having a separate POS engine that either duplicates the POS business logic on the existing stationary POS system and wireless POS system or replace/upgrade the existing stationary POS system to wireless POS system. Further, systems and methods exist for introducing mobile POS functionality by introducing various integration methodologies to the existing POS systems. For example, existing technologies either integrate at the presentation/User Interface (UI) layer or integrate with store server components of existing POS system. However, a system for seamless integration of wireless devices to the register side software of the existing POS system does not exist that would facilitate POS operations in an efficient, optimized and scalable manner.

In light of the above, there is a need for an effective system and method for extending the POS functionality to wireless devices by integrating wireless devices with existing POS system. Further, there is a need for a system and method that would efficiently integrate one or more wireless devices with the register side software of the existing POS system and reuse the business logic and rules of the existing POS system.

### SUMMARY OF THE INVENTION

A method for extending point of sale functionalities of an existing point of sale system is provided. In various embodiments of the present invention, the method comprises the step of building at least one Abstracted Core Register Point of Sale (ACR POS) module from at least one existing point of sale register application. The method further comprises the step of optimizing at least one ACR POS module for extending point of sale functionality to at least one wireless device. Further, the method comprises the step of mapping at least one wireless device to at least one virtual register module and at least one optimized ACR POS module to extend the point of sale functionalities of the existing point of sale system to the mapped wireless device. Furthermore, the method comprises the step of performing one or more point of sale tasks using the mapped wireless device.

In an embodiment of the present invention, building at least one Abstracted Core Register Point of Sale (ACR POS) module from at least one existing point of sale register application comprises de-activating one or more peripheral devices and their interaction with the existing point of sale register application. The method further comprises de-activating user interface dependencies from the existing point of sale register application. Further, the method comprises building a command execution module for the existing point of sale register application. Furthermore, the method comprises building a data extraction module for the existing point of sale register application.

In another embodiment of the present invention, optimizing at least one ACR POS module for extending point of sale functionality to at least one wireless device is facilitated by performing memory and performance optimization. The memory and performance optimization at least comprises pre-initializing required components, eliminating threads and modules which are required for updating the user interface and peripheral interactions, dynamic reloading of the ACR POS module components, restricting loading of the existing POS system specific components which are not required for extending point of sale functionality to wireless device, and any other suitable optimizing methodology.

In yet another embodiment of the present invention, optimizing at least one ACR POS module is facilitated by using multi instance execution model. The multi instance execution model at least comprises multi-process execution model, multi-thread execution model and any other suitable multi instance execution model.

In yet another embodiment of the present invention, mapping at least one wireless device to at least one virtual register module and at least one optimized ACR POS module to extend the point of sale functionalities of the existing point of sale system to the mapped wireless device comprises creating a mapping node corresponding to at least one wireless device. The method further comprises mapping at least one virtual register module to the mapping node. Further, the method comprises mapping at least one optimized ACR POS module to the mapping node.

In yet another embodiment of the present invention, performing one or more point of sale tasks using the mapped wireless device comprises receiving a service request from the mapped wireless device by a mobile point of sale server. The method further comprises generating one or more commands using parameters received from service request. A virtual register facilitates generating one or more commands using a point of sale adapter layer. Further, the method comprises sending the one or more commands to the mapped ACR POS module. Furthermore, the method comprises processing the one or more commands by existing business logic layer components residing in the mapped ACR POS module to generate a response. The method further comprises transmitting the response to the mapped virtual register module. Further, the method comprises processing the response by the mapped virtual register module to generate a message. The method further comprises transmitting the message to the mapped wireless device.

In yet another embodiment of the present invention the one or more point of sale tasks may at least comprise barcode scanning, cash tendering, generating receipt, printing receipt, canceling transactions, retrieving transactions, suspending transactions, accepting electronic signatures, e-mailing receipt, viewing transaction history, viewing offers and schemes, issuing gift cards, handling gift card inquiries, accepting credit/debit/gift cards, or any other point of sale task.

A system for extending point of sale functionalities of an existing point of sale system is provided. In various embodiments of the present invention, the system comprises one or more wireless devices configured to generate one or more service requests to perform one or more point of sale tasks. Each wireless device further comprises a mobile point of sale device application. The system further comprises a mobile point of sale server configured to integrate the one or more wireless devices with the existing point of sale system. The mobile point of sale server further comprises one or more virtual register modules configured to generate one or more commands pertaining to the one or more service requests and further configured to send the generated one or more commands to at least one Abstracted Core Register Point of Sale (ACR POS) module and one or more ACR POS module configured to facilitate processing the one or more commands pertaining to the one or more service requests using business logic layer components of an existing point of sale register application of the existing point of sale system. The at least one wireless device is mapped with at least one virtual register module and at least one ACR POS module.

In an embodiment of the present invention, the mobile point of sale server further comprises a service infrastructure layer configured to interface at least one wireless device to the mapped at least one virtual register module and further configured to dispatch the one or more service requests from the at least one wireless device to the mapped at least one virtual register module.

In another embodiment of the present invention, the one or more virtual register modules further comprises a virtual register configured to handle one or more service requests and further configured to facilitate generating one or more commands pertaining to the received one or more service requests from the at least one wireless device. The system further comprises a service handling layer comprising one or more service handlers configured to facilitate servicing one or more functionalities pertaining to the received one or more service requests. Further, the system comprises a point of sale adapter layer configured to generate one or more commands pertaining to the received one or more service requests and further configured to send the generated one or more commands to the mapped at least one ACR POS module.

In yet another embodiment of the present invention, the ACR POS module further comprises a command execution module configured to facilitate execution of one or more commands pertaining to the one or more service requests. The system further comprises business logic layer components configured to facilitate processing of the executed one or more commands. Further, the system comprises data access layer components configured to access data from a store server database to facilitate processing of the executed one or more commands. Furthermore, the system comprises a data extraction module configured to facilitate extracting updated data pertaining to the processed one or more commands.

In yet another embodiment of the present invention, the system further comprises a network configured to connect the one or more wireless devices to the mobile point of sale server.

In yet another embodiment of the present invention, the mobile point of sale device application comprises a mobile application user interface layer, a device peripheral abstraction layer, a mobile application business logic layer, and a mobile application data access layer.

### BRIEF DESCRIPTION OF THE ACCOMPANYING DRAWINGS

The present invention is described by way of embodiments illustrated in the accompanying drawings wherein:

FIG. 1 is a block diagram illustrating a system for extending the Point of Sale (POS) functionalities of an existing POS system to one or more wireless devices in accordance with an embodiment of the present invention;

FIG. 2 is a detailed block diagram illustrating an existing POS register application in accordance with an embodiment of the present invention;

FIG. 3 is a detailed block diagram illustrating a service infrastructure layer of the Mobile Point of Sale (MPOS) server in accordance with an embodiment of the present invention;

FIG. 4 is a detailed block diagram illustrating a virtual register module and Abstracted Core Register POS (ACR POS) module of the MPOS server in accordance with an embodiment of the present invention;

FIG. 5 is a detailed block diagram illustrating an MPOS device application installed on a wireless device to facilitate extending the POS functionalities of an existing POS system to the wireless device in accordance with an embodiment of the present invention;

FIG. 6 is a flowchart illustrating a multi-stage process of extending existing POS register application to a wireless device to facilitate seamless and efficient integration with the existing POS system register side software in accordance with an embodiment of the present invention;

FIG. 7 is a flowchart illustrating a method for building ACR POS module from an existing POS register application in accordance with an embodiment of the present invention;

FIG. 8 is a flowchart illustrating a method for creating mapping node between a wireless device, a virtual register module, and an ACR POS module in accordance with an embodiment of the present invention;

FIG. 9 is a flowchart illustrating a method for performing one or more POS task using a wireless device seamlessly integrated with an existing POS system through MPOS server in accordance with an embodiment of the present invention; and

FIG. 10A, FIG. 10B, and FIG. 10C is a flowchart illustrating an ‘add item’ data flow using a wireless device integrated to an existing POS system in accordance with an embodiment of the present invention.

### DETAILED DESCRIPTION OF THE INVENTION

A system and method for extending the Point of Sale (POS) functionalities of an existing POS system to one or more wireless devices is described herein. The invention provides a system and method that integrates the existing POS system to multiple wireless devices using an MPOS server. The MPOS server integrates the wireless device with the register side software of the existing POS system and reuses the business logic and rules of the existing POS system. Further, the invention facilitates performing various POS tasks using wireless devices such as, but not limited to, iOS devices, Windows mobile devices, Windows phone devices, smart phones, Personal Digital Assistants (PDAs), Blackberry, androids, palmtops, laptops, handheld devices, portable devices, mobile devices, handheld scanners, etc. The POS operations include various operations such as, but not limited to, point of purchase operations, checkout operations, etc.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

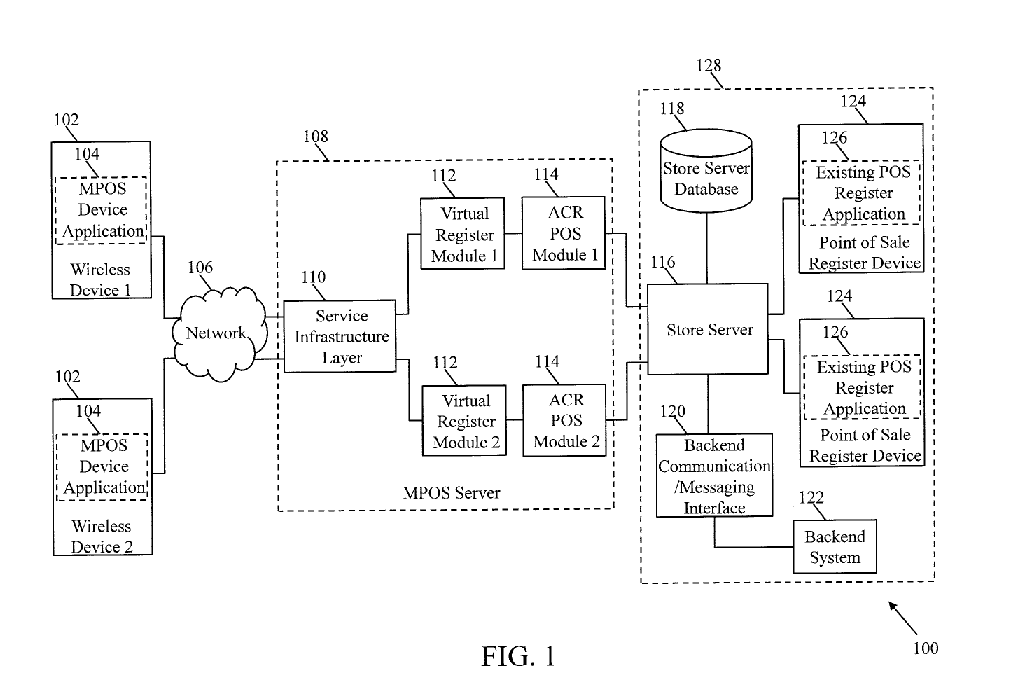

FIG. 1 is a block diagram illustrating a system for extending the Point of Sale (POS) functionalities of an existing POS system to one or more wireless devices in accordance with an embodiment of the present invention. The system 100 comprises of one or more wireless devices 102, a network 106, an MPOS server 108 and an existing POS system 128. The wireless device 102 is installed with the MPOS device application 104 to facilitate performing various POS tasks. Further, the MPOS server 108 comprises service infrastructure layer 110, one or more virtual register modules 112 and one or more ACR POS modules 114. In an embodiment of the present invention, the existing POS system 128 may comprise a store server 116, a store server database 118, a backend communication/messaging interface 120, a backend system 122, and one or more POS register devices 124. The POS register device 124 further comprises an existing POS register application 126.

The wireless devices 102 are electronic computing devices that are integrated with the register side software of an existing POS system through an MPOS server to facilitate performing various POS tasks. The wireless devices 102 may include, but not limited to, iOS devices, Windows mobile devices, Windows phone devices, smart phones, Personal Digital Assistants (PDAs), Blackberry, androids, palmtops, laptops, handheld devices, portable devices, mobile devices, handheld scanners, etc. In an embodiment of the present invention, the user can perform various POS tasks such as, but not limited to, user authentication, barcode scanning, manually entering product code, product lookup, cash tendering, void cash tendering, void item, void transaction, card tendering support, Magnetic Strip Reader (MSR) support, capturing signature, void card (gift/debit/credit) tendering, Customer Relationship Management (CRM) system integration, chip and pin card reader support, receipt based recall, internationalization support such as supporting multiple languages; multiple currencies; date and time format, etc., inter store lookup for product availability, 3^{rd} party card balance inquiry, printing receipt, retrieving transactions, suspending transactions, accepting electronic signatures, customer data acquisition, e-mailing receipt etc. using the wireless device 102.

In various exemplary embodiments of the present invention, the various POS options are rendered on the display of the user's wireless device 102. In an embodiment of the present invention, the user may select one or more options from the various options rendered on the user's wireless device 102 to perform one or more POS tasks. In another embodiment of the present invention, the user of the wireless device 102 includes, but not limited to, sales assistants, sales executives, sales personnel, store keepers, employees, etc.

The MPOS device application 104 is a software program that facilitates providing an interface to the user to perform one or more POS tasks. Further the MPOS device application 104 facilitates generating service requests pertaining to the selected option to perform requisite POS tasks. Furthermore, the user interface content and workflow is managed by the MPOS device application 104 which facilitates integrating wireless devices from different mobile platforms to the same MPOS server without rebuilding/changing the server and its applications. Also, the MPOS device application 104 has a user interface navigational framework independent of existing POS workflow. In an embodiment of the present invention, the MPOS device application 104 may re-sync to transaction state in case of device restart, accidental exit of MPOS device application, etc.

In various exemplary embodiments of the present invention, the MPOS device application 104 may include, but not limited to, a web based application, portal, web portal, application suite, graphical user interface, character user interface, touch screen interface, etc. In another embodiment of the present invention, the user of the wireless device 102 enters authentication data to access various appropriate options provided by the MPOS device application 104 to perform related POS tasks. In yet another exemplary embodiment of the present invention, the MPOS device application 104 facilitates a sales assistant to access various options such as, but not limited to, barcode scanning, product lookup, receipt based recall, generating receipt, printing receipt, etc. using the wireless device 102. In various embodiments of the present invention, the MPOS device application 104 may generate one or more service requests related to the option selected by the user to perform one or more POS tasks. Further, the generated service request is transmitted to the MPOS server 108 which integrates the wireless device 102 to the register side software of the existing POS system.

In an embodiment of the present invention, the user may have the MPOS device application 104 pre-installed on the wireless device 102. In another embodiment of the present invention, the user may enter the appropriate URL or web address to access the MPOS device application 104 on his wireless device. In yet another embodiment of the present invention, the user may log into the POS system by entering his authentication details such as, but not limited to, customer ID, user ID, login ID, password, Personal Identification Number (PIN), etc through the MPOS device application 104 installed on the wireless device.

Network 106 is a wireless communication network to facilitate connection between wireless devices 102 and mobile POS server 108. In various embodiments of the present invention, the network 106 includes, but not limited to, Wi-Fi, bluetooth, wireless cellular network, ZigBee, wireless local area network, wireless personal area network, etc. In an exemplary embodiment of the present invention, the network 106 facilitates transmitting service requests from the one or more wireless devices 102 to the MPOS server 108.

The MPOS server 108 is a software module capable of extending the POS functionalities of an existing POS system to one or more wireless devices. The MPOS server 108 facilitates integration of the one or more wireless devices 102 with the register side software of the existing point of sale system. The MPOS server 108 further comprises a service infrastructure layer 110, one or more virtual register modules 112, and one or more ACR POS modules 114.

The service infrastructure layer 110 facilitates interfacing of the one or more wireless devices 102 to the virtual register module 112. The service infrastructure layer 110 facilitates managing the session between the wireless device and the virtual register module 112. Furthermore, the service infrastructure layer 110 dispatches the service requests generated by the wireless device 102 to the virtual register module 112.

The virtual register module 112 facilitates handling requests from the wireless device 102. The virtual register module is mapped with a particular wireless device 102. Further, the virtual register module 112 handles service requests from the mapped wireless device 102. The virtual register module 112 comprises service handlers and adapter layer components to facilitate handling service requests. Furthermore, the virtual register module 112 facilitates interfacing with the business logic layer components of the existing point of sale system. The virtual register layer generates one or more commands to invoke a specific business logic layer API or business logic layer function in the ACR POS module 114.

The ACR POS module 114 is a software application that facilitates processing the service requests from a particular wireless device using the business logic layer components of the existing point of sale system. The ACR POS module 114 comprises command execution module and data extraction module that facilitate processing the one or more commands generated by the virtual register module using the business logic layer components and data access layer components of the existing POS system. In an embodiment of the present invention, the ACR POS module 114 is built by modifying the existing POS register application 126. In various embodiments of the present invention, POS register device and peripheral components and their interaction with the existing POS register application 126 are removed or deactivated from the existing POS register application 126 to facilitate building an ACR POS module 114. Also, user interface dependencies are removed or de-activated from the existing POS register application 126. In an embodiment of the present invention, the command execution module and data extraction module may exist in the existing POS register application 126 and exposed from the application for external usage through inter-process communication mechanisms or interfaces to facilitate building an ACR POS module 114. In another embodiment of the present invention, a command execution module and data extraction module are created and embedded in the ACR POS module 114 if they do not already exist in the existing POS register application 126. The business logic layer and data access layer of the existing POS register application are used by the ACR POS module to integrate the wireless device with register side software of the existing POS system and facilitate re-using the residing business logic and rules of the existing POS system.

The existing POS system 128 is the legacy POS system which is capable of performing various POS tasks. The existing POS system 128 includes point of purchase systems, checkout systems, point of service systems, etc. In an embodiment of the present invention, the existing POS system 128 may be an ordinary POS system having stationary POS register-boxes. In another embodiment of the present invention, the POS system may comprise a web based POS application installed on a computer. In various embodiments of the present invention, the existing POS system 128 may be installed at various locations including, but not limited to, retail store, shop, supermarket, superstore, restaurant, etc. In an embodiment of the present invention, the existing point of sale system 128 comprises a store server 116, a store server database 118, a backend communication/messaging interface 120, a backend system 122, and one or more POS register devices 124. The POS register device 124 further comprises an existing POS register application 126.

The store server 116 manages and controls various operations and network resources of the existing POS system to facilitate performing various POS tasks. In various embodiments of the present invention, the store server 116 handles the service requests from one or more POS register devices and provides appropriate services. The store server 116 accesses the store server database 118 to retrieve and store information pertaining to POS tasks. In an embodiment of the present invention, the store server 116 may receive a request to retrieve customer profile from the store server database 118. In another embodiment of the present invention, the store server 116 may facilitate payment processing. In yet another embodiment of the present invention, the store server 116 facilitates processing of service requests received from one or more wireless devices 102 via the MPOS server 108.

The store server database 118 is the central repository or storage to store data pertaining to the existing POS system 128. In an embodiment of the present invention, the store server database 118 stores data including, but not limited to, authentication details, transaction histories, discount offers and schemes, financial records, etc. In various embodiments of the present invention, the store server database 118 includes, but not limited to, web-based storage, localized storage, cloud storage, etc.

The backend communication/messaging interface 120 communicates with backend system 122 to provide backend services. In an embodiment of the present invention, the backend communication/messaging interface 120 may send credit card authentication data to a banking server to facilitate payment processing.

The backend system 122 are one or more systems that provide additional services to the existing POS system 128. In various embodiments of the present invention, the backend system 122 includes, but not limited to, credit card authorization system, financial system, banking server, etc.

The one or more POS register devices 124 are electronic computing devices which facilitate various POS tasks. In various embodiments of the present invention, the POS register devices 124 include, but not limited to, desktops, laptops, POS registers, computers, cash-registers, self-checkout machines, etc. In an exemplary embodiment of the present invention, a computer at the check-out area of a retail store may be installed with an existing POS register application to facilitate various POS tasks. In another embodiment of the present invention, there may be various peripheral devices such as, but not limited to, barcode scanners, printers, Magnetic Stripe Readers (MSR), security tag removers, barcode scanners, handheld scanners, etc. attached to the one or more POS register devices 124 to facilitate various POS tasks. In yet another embodiment of the present invention, the POS register device 124 may be a cash-register with a printer, MSR, barcode scanner, and security tag remover connected to it to facilitate POS tasks. In various embodiments of the present invention the POS register device 124 is installed with an existing POS register application 126 to facilitate POS functionalities.

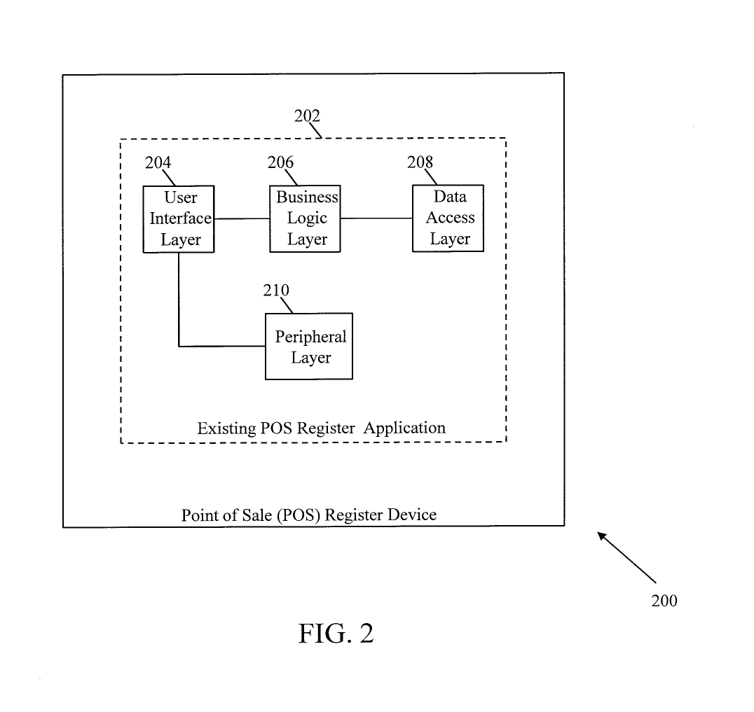

FIG. 2 is a detailed block diagram illustrating an existing POS register application in accordance with an embodiment of the present invention. The existing POS register application 202 comprises a user interface layer 204, a business logic layer 206, a data access layer 208 and a peripheral layer 210.

The existing POS register application 202 is a software application that facilitates providing an interface to the user to perform one or more POS tasks. Further, the existing POS register application 202 facilitates processing of service requests to perform one or more point of sale tasks. Furthermore, the existing POS register application 202 facilitates interaction with various peripheral devices.

The user interface layer 204 comprises software modules of application programs that use data stored in the data access layer to perform various POS tasks. In an embodiment of the present invention, the user interface layer 204 includes, but not limited to, graphical user interface, character user interface, web based interface, web portal, application suite etc. In another embodiment of the present invention, the user interface layer 204 provides various options such as, but not limited to, barcode scanning, product/price lookup, suspend, resume, cash tendering, employee login/logoff, add item, void item, credit card tendering, gift card tendering, void credit/gift card tender, MSR support, E-receipt, encryption support, register open/close, training mode support, receipt printing, transaction level discount, gift receipt tendering, price modify, void after, add/remove fee code, employee discount, suspend receipt, gift card balance inquiry, 3^{rd} party gift card balance inquiry, gift card, receipt based recall, etc. to perform the requisite POS task.

The business logic layer 206 comprises software modules that serve as a communication liaison between the user interface layer and the data access layer. In various embodiments of the present invention, the business logic layer 206 comprises business logic layer components such as, but not limited to, one or more business logic layer APIs or business logic layer functions that facilitate performing a particular point of sale task. Further, business logic layer components are a particular set of rules and specifications to facilitate performing a particular point of sale task. In an embodiment of the present invention, the user interface layer 204 may issue requests to the business logic layer 206 to retrieve data related to the received requests through the data access layer 208. Further, the business logic layer 206 may apply one or more business rules to the request prior to retrieving data from the data access layer 208. The business logic layer 206 may apply one or more business rules and/or logic to each request received from the user interface layer 204.

The data access layer 208 comprises software modules to facilitate access to data stored in various data storages of the existing POS system. In an embodiment of the present invention, the data access layer 208 may have file structures having standard identifiers such as, but not limited to, path and file name that are recognized by the data access layer 208 and the business logic layer 206. Further, the data access layer 208 may receive a request in the form of standard identifiers from the user interface layer 204 to retrieve specific data stored at a particular storage location. Furthermore, the business logic layer 206 may manage the request received from the user interface layer 204 and retrieve data from the data access layer 208 based on a specific business rule and/or logic to perform a specific POS task. In an embodiment of the present invention, the business rules applied by the business logic layer 206 may relate to verification of authentication details entered by the sales assistant using the POS register device 200 to request access to customer data through the data access layer 208.

The peripheral layer 210 comprises modules to facilitate integration with various peripheral devices. The peripheral layer 210 facilitates integration of peripheral devices such as, but not limited to, barcode scanner, MSR, Signature pad, PIN pad, etc. to the POS register device. The peripheral layer 210 communicates with the user interface layer 204 to facilitate user interaction with peripheral devices.

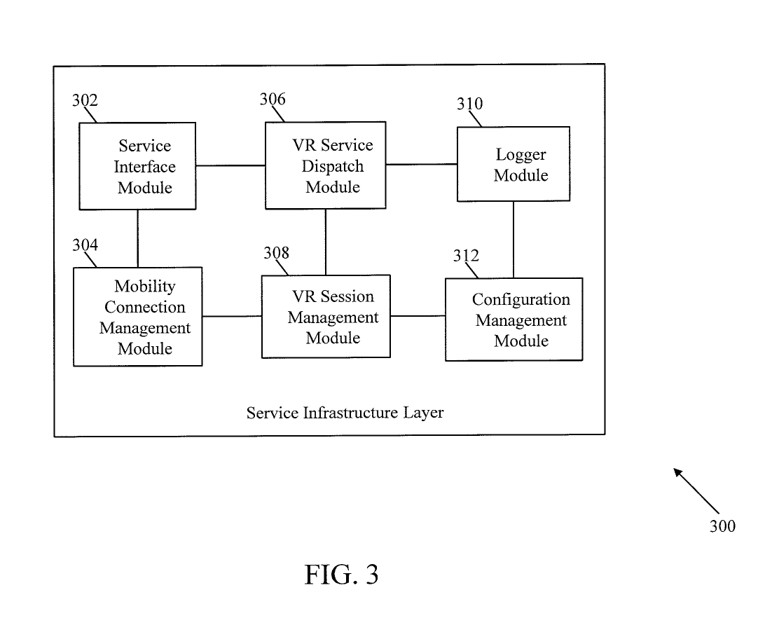

FIG. 3 is a detailed block diagram illustrating a service infrastructure layer of the MPOS server in accordance with an embodiment of the present invention. The service infrastructure layer 300 interfaces one or more wireless devices to the appropriate virtual register modules. The service infrastructure layer 300 comprises a service interface module 302, a mobility connection management module 304, a Virtual Register (VR) service dispatch module 306, a VR session management module 308, a logger module 310, and a configuration management module 312.

The service interface module 302 is a software module which receives service requests from wireless devices. In an embodiment of the present invention, the service interface module 302 handles service requests from the connected one or more wireless devices. The received service requests are sent to the VR service dispatch module 306.

The mobility connection management module 304 is a module which handles mobility and connectivity aspects of the one or more wireless devices with the one or more virtual register modules. Further, the mobility connection management module 304 eliminates duplicate request processing. The mobility connection management module 304 manages the session between the wireless device and the virtual register module.

The VR service dispatch module 306 is a software module that facilitates dispatching of the received one or more service requests to the appropriate virtual register module. In an embodiment of the present invention, the VR service dispatch module 306 receives service requests from the service interface module 302 and dispatches to appropriate virtual register module.

The VR session management module 308 is a module that manages sessions between the virtual register module and the connected wireless device. Further, the VR session management module 308 facilitates handshaking and synchronization between wireless devices and the mobile POS server. Furthermore, the VR session management module 308 generates unique identifier for the wireless device. The wireless device sends the unique identifier along with service request to the MPOS server to maintain the integrity of the POS transaction.

The logger module 310 is a log file that sequentially records the activities and events of the service infrastructure layer 300. The configuration management module 312 is a software module which manages the configuration and performance of the service infrastructure layer 300.

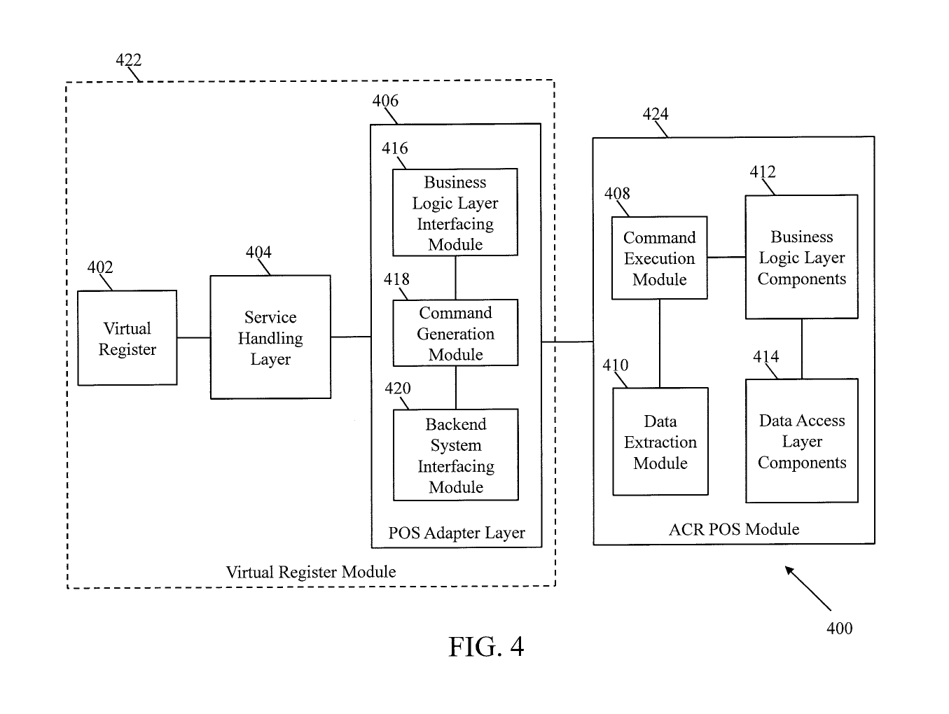

FIG. 4 is a detailed block diagram illustrating a virtual register module and an ACR POS module of the MPOS server in accordance with an embodiment of the present invention. The virtual register module 422 comprises a virtual register 402, a service handling layer 404, and a POS adapter layer 406. The ACR POS module 424 comprises a command execution module 408, a data extraction module 410, business logic layer components 412, and data access layer components 414.

The virtual register module 422 facilitates handling service requests from the connected wireless device. The virtual register module is mapped to a particular wireless device and caters to its service requests.

The virtual register 402 facilitates handling service requests from a specific wireless device. Further, the virtual register 402 forwards service requests to the appropriate service handler of the service handling layer 404. Furthermore, the virtual register 402 facilitates generating one or more commands pertaining to the service request using POS adapter layer 406.

The service handling layer 404 is a software layer comprising one or more service handlers. Further, the service handlers are functional interfaces that facilitate servicing a single functionality such as, but not limited to, Login, Logoff, start transaction, etc. The service handling layer 404 may have various service handlers which may service one or more specific functionality. The virtual register module 422 uses one or more service handlers to cater to one or more requests from the connected wireless device 102 (FIG. 1). The service handling layer 404 includes service handlers such as, but not limited to, Login service handler, Logoff service handler, start transaction service handler, end transaction service handler, add item service handler, void item service handler, add cash tender service handler, void cash tender service handler, or any other service handler.

The POS adapter layer 406 is a module that maps requests from the wireless device to the business logic layer components residing in the ACR POS module. The POS adapter layer 406 facilitates interfacing to the existing POS system and other backend systems. The POS adapter layer 406 comprises business logic layer interfacing module 416, command generation module 418, and backend system interfacing module 420.

The business logic layer interfacing module 416 is a software module that facilitates interfacing of the wireless device with the business logic layer components of the existing POS system. In an embodiment of the present invention, the business logic layer interfacing module 416 facilitates interfacing of the connected wireless device to the business logic layer components 412 residing in the ACR POS module.

The command generation module 418 facilitates creating one or more commands to invoke one or more specific business logic layer Application Programming Interfaces (API) or business logic layer functions using parameters related to service request received from the connected wireless device. In various embodiments of the present invention, the command generation module 418 creates one or more commands which are transmitted to the command execution module 408.

The backend system interfacing module 420 is a software module that provides interfaces to backend systems. The backend system includes, but not limited to, credit card authorization system, banking server, debit card authorization system, etc.

The ACR POS module 424 is a software application comprising its own copy of business logic layer components and data access layer components. The existing POS register application 126 (FIG. 1) is modified to build an ACR POS module 424. The ACR POS module comprises business logic layer components and data access layer components residing in the existing POS register application. Further, the ACR POS module 424 comprises command execution module and data extraction module. Furthermore, the ACR POS module 424 is optimized for minimal memory foot print, minimal processing time and multi instance side by side execution on the MPOS server. The business logic layer components perform execution of one or more commands independent of other ACR POS modules 424.

In an embodiment of the present invention, the MPOS server comprises one or more virtual register modules 422 and one or more ACR POS module 424 running on independent and exclusive threads or processes and preloaded at startup for faster execution of service requests. The virtual register module 422 and ACR POS module 424 executes the service requests sequentially without overlapping request execution. The ACR POS module 424 comprises a command execution module 408, a data extraction module 410, business logic layer components 412, and data access layer components 414.

The command execution module 408 is a software module that facilitates execution of one or more commands to invoke one or more specific business logic layer APIs or business logic layer functions, generate response and send back to the wireless device via virtual register module. In various embodiments of the present invention, the command execution module 408 facilitates executing one or more commands to invoke one or more specific APIs of the business logic layer components 412 to facilitate performing the requisite POS task. In an embodiment of the present invention, the command execution module 408 may exist in the existing POS register application and exposed from the application for external usage through inter-process communication mechanisms or interfaces. In another embodiment of the present invention, a command execution module 408 is created and embedded in the ACR POS module if it does not exist in the existing POS register application.

The data extraction module 410 is a software module that facilitates extracting data from the data structures of the ACR POS module/existing POS register application. The data extraction module 410 facilitates extracting updated data after execution and processing of the one or more commands. The updated data may comprise information such as, but not limited to, requested data, updates, confirmations, transaction data, etc. In an embodiment of the present invention, the data extraction module may be present in the existing POS register application and re-used by command execution module 408. In another embodiment of the present invention, a data extraction module 410 is created and embedded in the ACR POS module if it does not exist in the existing POS register application.

In various embodiments of the present invention, the internal data structures of the ACR POS module are updated after execution of one or more commands. The data extraction module 410 collects the required data from the data structures of the ACR POS module/existing POS register application and transmits to virtual register module.

The business logic layer components 412 are software modules comprising business logic layer APIs and business logic layer functions of the existing POS system. The business logic layer components 412 exist in the business logic layer of the existing point of sale register application. The business logic layer of the existing POS register application is fully reused while building an ACR POS module from the existing POS register application. The business logic layer components 412 facilitate processing the service requests based on the business rules and logic of the existing POS system. Further, the business logic layer components 412 may be divided into various different software modules such as business logic layer APIs or business logic layer functions that perform various specific functions to facilitate performing a particular POS task. In an embodiment of the present invention, the business logic layer components 412 may apply one or more business rules to the service request, retrieve data from the data access layer, and transmit the response to virtual register module. The business logic layer components 412 facilitate processing of the one or more commands by one or more specific business logic layer APIs or business logic layer functions.

The data access layer components 414 comprises software modules to facilitate access to data stored in various data storages of the existing POS system. The data access layer components 414 exist in the data access layer of the existing point of sale application. The data access layer of the existing POS register application is fully reused while building an ACR POS module from the existing POS register application. The data access layer components facilitate extracting data from the store server database and storages of the existing POS system to facilitate performing a POS task.

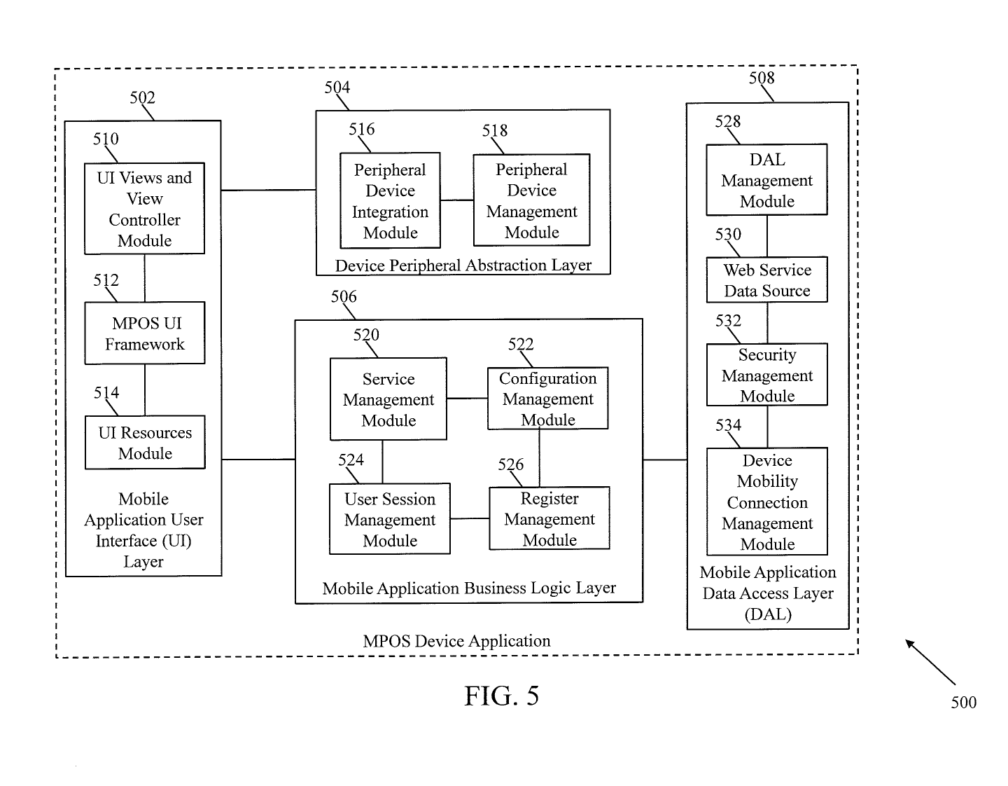

FIG. 5 is a detailed block diagram illustrating an MPOS device application installed on a wireless device to facilitate extending the POS functionalities of an existing POS system to the wireless device in accordance with an embodiment of the present invention. The MPOS device application 500 comprises a mobile application User Interface (UI) layer 502, a device peripheral abstraction layer 504, a mobile application Business Logic Layer (BLL) 506, and a mobile application Data Access Layer (DAL) 508.

The mobile application UI Layer 502 provides an interface to facilitate the user to perform various POS tasks using the wireless device. The mobile application UI Layer 502 provides various options to perform one or more POS task such as, but not limited to, barcode scanning, manually entering barcode, product lookup, cash tendering, etc. In an embodiment of the present invention, the mobile application UI Layer 502 includes, but not limited to, graphical user interface, character user interface, web based interface, web portal, application suite, etc. In various embodiments of the present invention, mobile application UI Layer 502 issues request to mobile application BLL 506 to perform one or more POS tasks selected by the user through the user interface provided by the MPOS device application 500 on the wireless device.

The mobile application UI Layer 502 comprises UI views and View controller module 510, MPOS UI Framework 512, and UI Resources module 514. The UI views and view controller module 510 contains individual views and their controllers. The MPOS UI framework 512 is a software module that contains one or more custom built components. In an embodiment of the present invention, the MPOS UI framework 512 provides a screen manager that controls the creation of views and enables seamless navigation between the views and their management. The UI resources module 514 is a module containing resources such as, but not limited to, icons, background images, splash screens, etc. In various embodiments of the present invention, the mobile application UI Layer 502 may also comprise one or more modules specific to a service including, but not limited to, signature capture module, receipt preview module, etc.

The device peripheral abstraction layer 504 comprises modules facilitating abstraction of the peripheral interaction to avoid dependency of MPOS device application 500 on the peripheral devices from specific vendors. The device peripheral abstraction layer 504 further comprises peripheral device integration module 516 and peripheral device management module 518. The MPOS device application 500 accesses the peripheral features through the abstract interfaces exposed by peripheral device management module 518. The peripheral device integration module 516 are one or more software modules that facilitate integration of one or more peripheral devices including, but not limited to, barcode scanners, printer, magnetic card reader, MSR, signature pad, PIN pad, etc. There are separate peripheral device integration module 516 such as, but not limited to, scanner integration module, MSR integration module, printer integration module, etc. to integrate different peripheral devices. The peripheral device management module 518 is a module that manages the one or more peripheral devices integrated to the wireless device through the device peripheral abstraction layer 504.

The mobile application BLL 506 comprises software modules that serve as a communication liaison between the mobile application UI Layer 502 and the mobile application DAL 508. Further, the mobile application BLL 506 manages service requests received from the mobile application UI Layer 502.

The mobile application BLL 506 further comprises service management module 520, configuration management module 522, user session management module 524, and register management module 526. The service management modules 520 are software modules that facilitate managing requests pertaining to different types of POS tasks such as, but not limited to, price lookup, handling transactions, gift card inquiry, cash tendering, card tendering, product lookup, etc. In an embodiment of the present invention, there may be separate service management modules 520 for various services including, but not limited to, transaction management module, price lookup agent, gift card module, cash tendering module, product lookup agent, etc. The configuration management module 522 is a module that controls and manages the configuration of the wireless device. The user session management module 524 is a software module that facilitates managing the user session with the MPOS server through the MPOS device application 500. The register management module 526 facilitates managing cash register and provides features such as Register open, Register close, etc.

The mobile application DAL 508 facilitates routing the data to appropriate data sources such as the MPOS server, local database of the wireless device, etc. The mobile application DAL 508 comprises DAL management module 528, Web service data source 530, security management module 532, and device mobility connection management module 534.

The DAL management module 528 is a module that manages and controls the mobile application DAL 508 and its functionalities. In an embodiment of the present invention, the DAL management module 528 facilitates managing the data extraction requests placed through the MPOS device application 500. The web service data source 530 is a software module that facilitates leveraging the web service to extract data for one or more service requests. The security management module 532 facilitates secure communication and application level encryption of sensitive information such as, but not limited to, credit card information, financial information, etc. The security management module 532 facilitates secure communication over secure media such as, but not limited to, Hypertext Transfer Protocol Secure (HTTPS), Transport Layer Security (TLS), Secure Sockets Layer (SSL), etc. The device mobility connection management module 534 facilitates managing the connection between wireless device and the MPOS server.

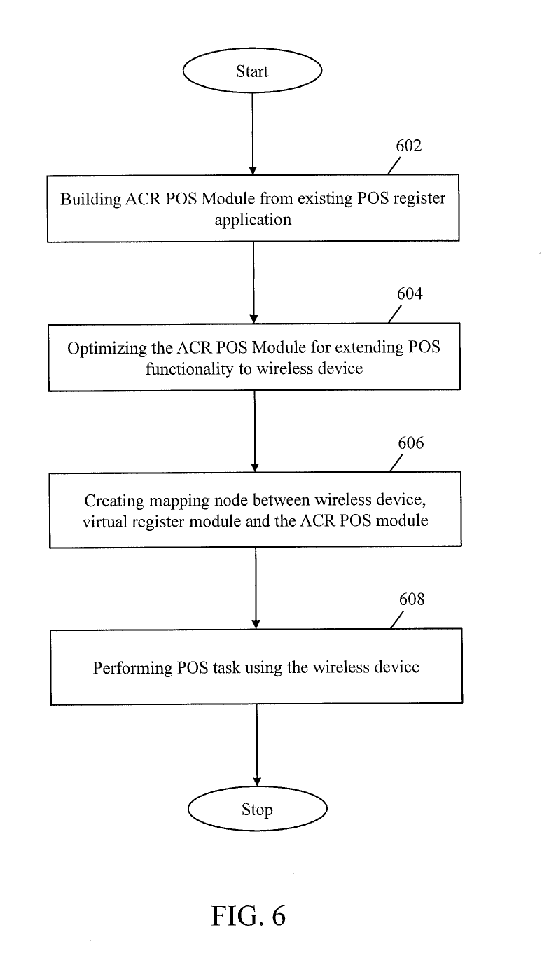

FIG. 6 is a flowchart illustrating a multi-stage process of extending existing POS register application to a wireless device to facilitate seamless and efficient integration with existing POS system register side software in accordance with an embodiment of the present invention.

At step 602, the existing POS register application is modified to build an ACR POS module. In an embodiment of the present invention, the ACR POS module is a software application facilitating processing of service requests using the business logic layer components and data access layer components of the existing POS system. In various embodiments of the present invention, POS register device and peripheral components and their interaction with the existing POS register application are removed or deactivated from the existing POS register application to facilitate building an ACR POS module. Also, user interface dependencies are removed or de-activated from the existing POS register application. In an embodiment of the present invention, the command execution module and data extraction module may exist in the existing POS register application and exposed from the application for external usage through inter-process communication mechanisms or interfaces to facilitate building an ACR POS module. In another embodiment of the present invention, a command execution module and data extraction module are created and embedded in the ACR POS module if they do not already exist in the existing POS register application. The business logic layer and data access layer of the existing POS register application are used by the ACR POS module to integrate the wireless device with register side software of the existing POS system and facilitate re-using the residing business logic and rules of the existing POS system.

At step 604, the ACR POS module is optimized for extending POS functionalities to one or more wireless devices. In various embodiments of the present invention the ACR POS module is optimized for memory and performance optimization. In an embodiment of the present invention the ACR POS module is optimized for minimal memory footprint by performing methodologies such as, but not limited to, restricting the loading of the existing POS system specific components which are not required for extending POS functionality to wireless devices, removal of methodologies that are used for improving display of existing POS system such as data caching, which are not required for extending POS functionality to wireless devices, and reloading or refreshing the components of ACR POS module. Further, memory footprint refers to the memory that a program uses or references while running. In another embodiment of the present invention, the ACR POS module may be optimized for minimal processing time using methodologies such as, but not limited to, pre-initialization of the required components, eliminating threads and modules which are required for updating user interface and peripheral interactions, dynamic reloading of the ACR POS module components etc.

In yet another embodiment of the present invention, the ACR POS module runs on exclusive threads/processes independent of other ACR POS modules to facilitate multi instance side by side execution on the MPOS server. In an embodiment of the present invention, each ACR POS module and its components run under one exclusive and independent thread in a multi thread execution model if the existing POS system has a layered architecture. In another embodiment of the present invention, each ACR POS module runs as a separate process in a multi process execution model if the existing POS system does not have well-defined components or layered architecture.

At step 606, a mapping node is created between a wireless device, a virtual register module and an ACR POS module. The mapping node comprises master configuration files which facilitate controlling the number of wireless devices supported by an MPOS server. The mapping node comprises mapping information such as, but not limited to, identification information for wireless device, identification information for virtual register module and identification information for ACR POS module. The mapping node maps a particular virtual register module and a particular ACR POS module to a single specific wireless device.

At step 608, the wireless device is used to perform various POS tasks. The wireless device is seamlessly integrated with the existing POS system and facilitates performing various POS tasks. In an embodiment of the present invention, the wireless device generates service request to perform a particular POS task. Further, the virtual register module facilitates generating one or more commands pertaining to the service request. Furthermore, the commands are sent to the ACR POS module and processed to generate a response.

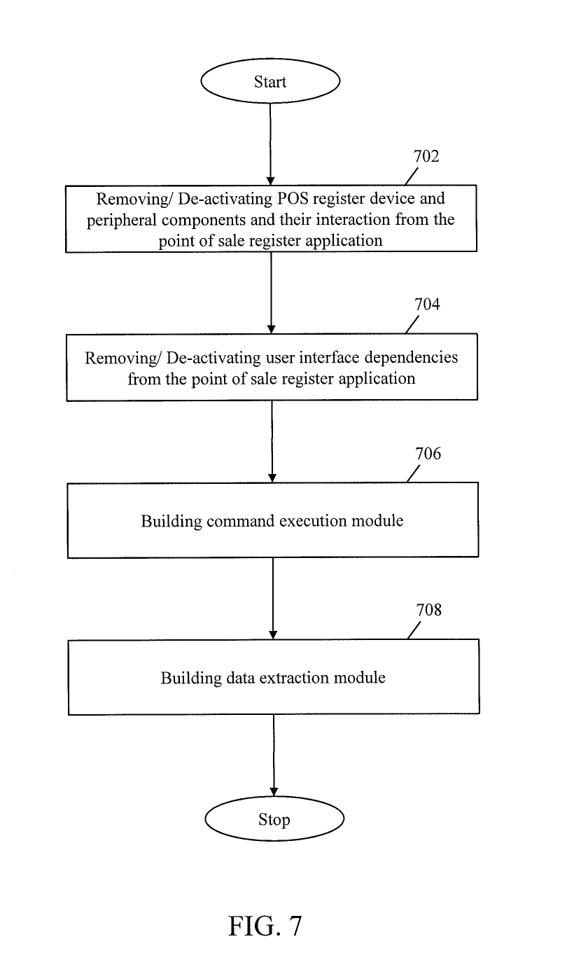

FIG. 7 is a flowchart illustrating a method for building an ACR POS module from an existing POS register application in accordance with an embodiment of the present invention.

At step 702, the POS register device and peripheral components and their interaction with existing POS register application is removed or de-activated. In an embodiment of the present invention, the POS register device and peripheral components includes, but not limited to, POS device, cash-registers, barcode scanners, printers, MSR, signature pad, PIN pad, etc.

At step 704, the user interface dependencies are removed from the existing point of sale register application. In various embodiments of the present invention, the UI layer dependencies are removed by adopting different methods depending on the code organization/architecture of the existing POS register application. In an embodiment of the present invention, the UI layer is removed if the architecture is layered. In another embodiment of the present invention, if the code organization/architecture is not layered, modules which are having user interface dependencies are conditionally compiled or stubbed to eliminate the UI dependency and facilitate common register software code base for ACR POS module and existing POS register application.

At step 706, the command execution module is built. In various embodiments of the present invention, the command execution module can accept one or more commands from external applications, execute the commands by invoking specific business logic layer APIs and business logic layer functions, generate the response and return it to the caller. In another embodiment of the present invention, the command execution module may exist in the existing POS register application and exposed from the application for external usage through Inter-process communication mechanisms or interfaces.

At step 708, the data extraction module is built. The data extraction module is a module that facilitates extracting data from the data structures of the ACR POS module/existing POS register application. In an embodiment of the present invention, the data extraction module may be present in the existing POS register application and re-used by command execution module. In another embodiment of the present invention, a data extraction module is created and embedded in the ACR POS module if it does not already exist in the existing POS register application. The data extraction module collects data from the data structures of the ACR POS module/existing POS register application and transmits to virtual register module.

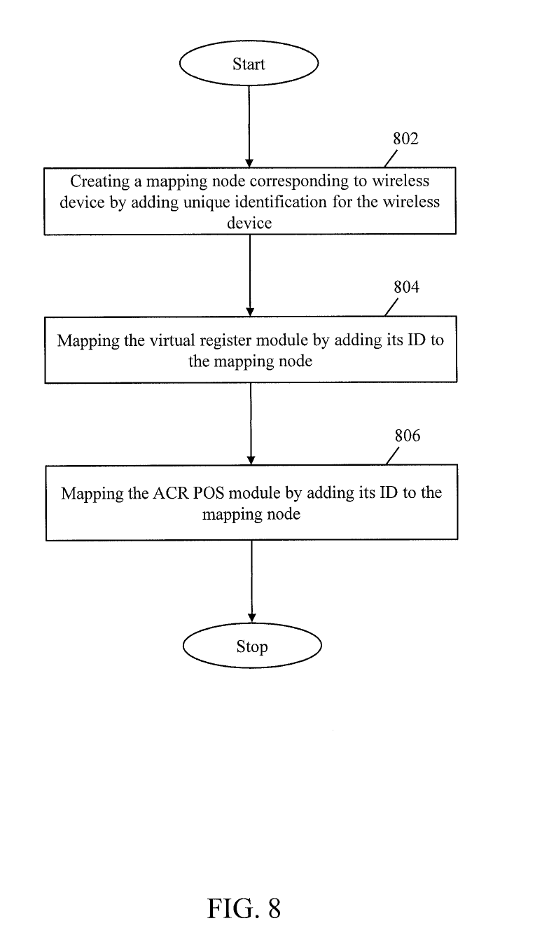

FIG. 8 is a flowchart illustrating a method for creating mapping node between a wireless device, a virtual register module, and an ACR POS module in accordance with an embodiment of the present invention.

At step 802, a mapping node is created corresponding to a wireless device by adding a unique identification for the wireless device. The mapping node comprises master configuration files which facilitate controlling the number of wireless devices supported by an MPOS server. In an embodiment of the present invention, the unique identification may include, but not limited to, Media Access Control (MAC) ID.

At step 804, the wireless device is mapped with a virtual register module by adding the virtual register identification information to the mapping node. In an embodiment of the present invention, the virtual register identification information may include, but not limited to, virtual register module ID or name.

At step 806, the ACR POS module is mapped to the mapping node by adding its identification information to the mapping node. In an embodiment of the present invention, the ACR POS module may have register ID known to the existing POS system.

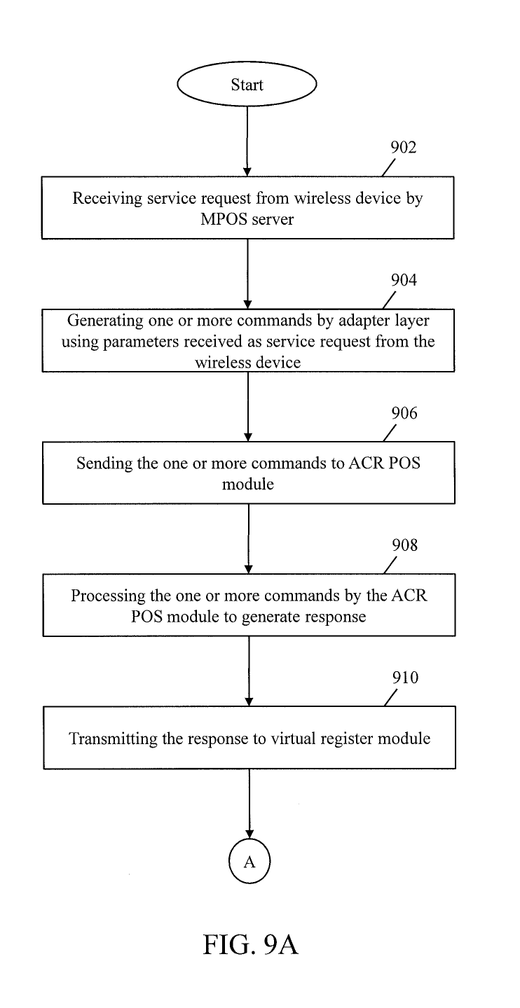

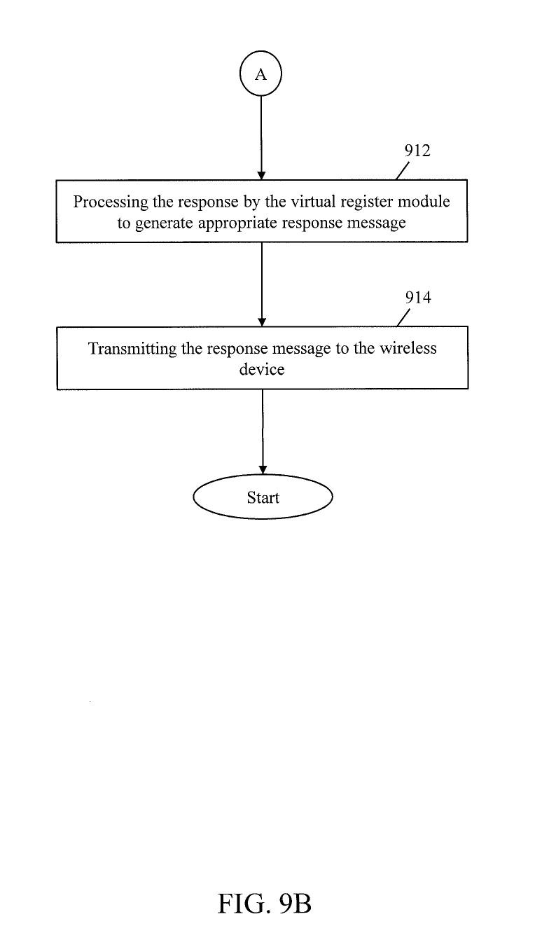

FIG. 9 is a flowchart illustrating a method for performing one or more POS task using a wireless device seamlessly integrated with an existing POS system through MPOS server in accordance with an embodiment of the present invention.

At step 902, the MPOS server receives service request from a wireless device. The service request comprises various parameters such as, but not limited to, product identifiers, device ID, user ID, and trans ID, that include information such as device identification information, device details, user identification, transaction identification information, service details, etc. The service request pertains to performing a particular POS task such as, but not limited to, adding an item, deleting an item, generating receipt, etc.

At step 904, the POS adapter layer generates one or more commands using the parameters received as service request from the wireless device. In an embodiment of the present invention, the virtual register facilitates generating one or more commands using POS adapter layer to invoke one or more specific business logic layer APIs or business logic layer functions of the ACR POS module to facilitate performing the POS task pertaining to the received service request.

At step 906, the POS adapter layer sends the one or more commands to the ACR POS module. At step 908, the ACR POS module processes the one or more commands to generate response. The business logic layer components of the existing point of sale system residing in the ACR POS module facilitate processing the received one or more commands to generate appropriate response.

At step 910, the ACR POS module transmits the response back to the virtual register module. The data extraction module residing in the ACR POS module facilitates extracting the response from the data structures of the ACR POS module and transmitting to the virtual register module. At step 912, the virtual register module processes the response to generate appropriate response message. At step 914, the virtual register module transmits the response message to the wireless device.

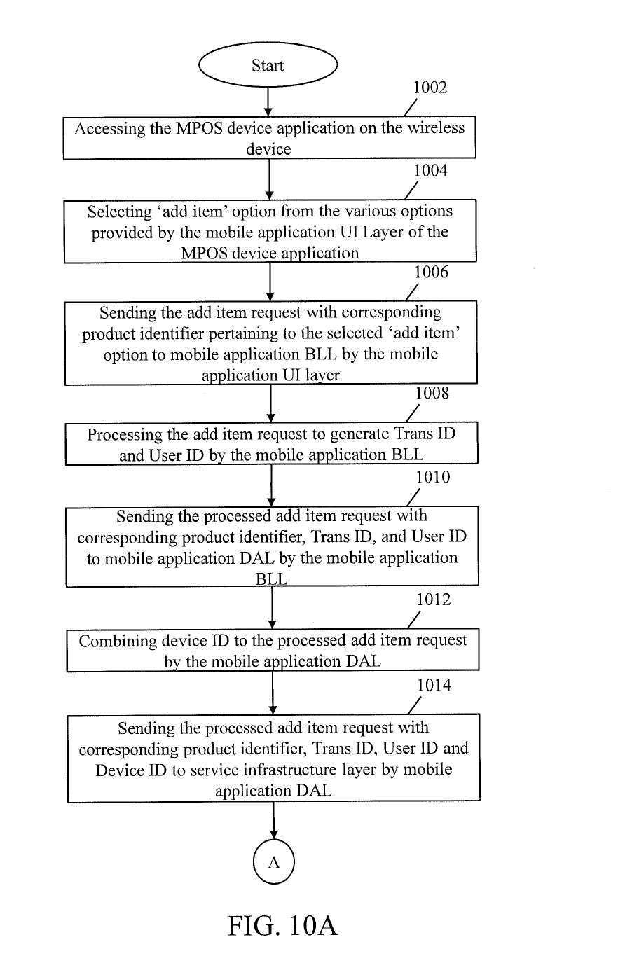

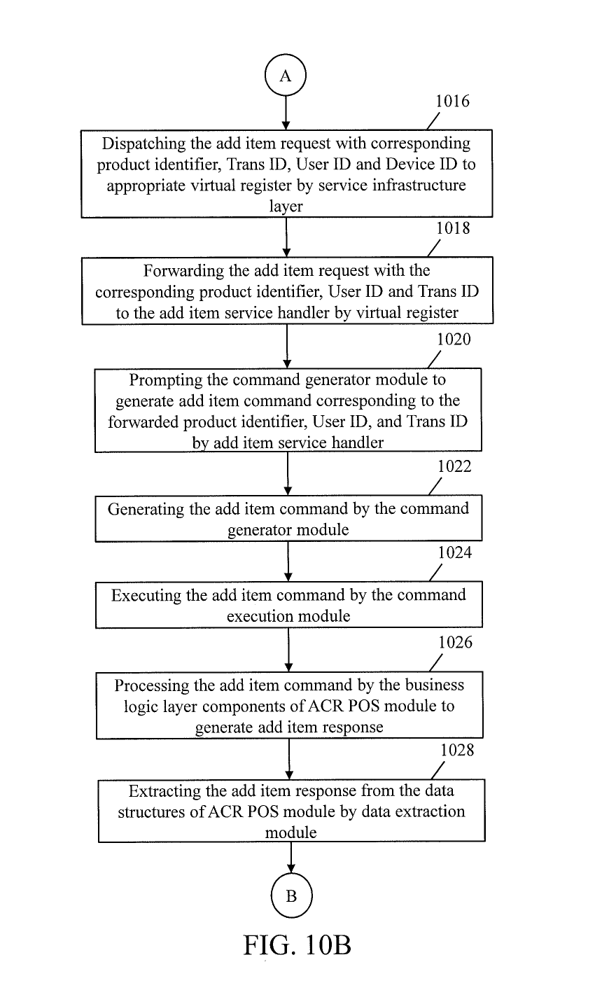

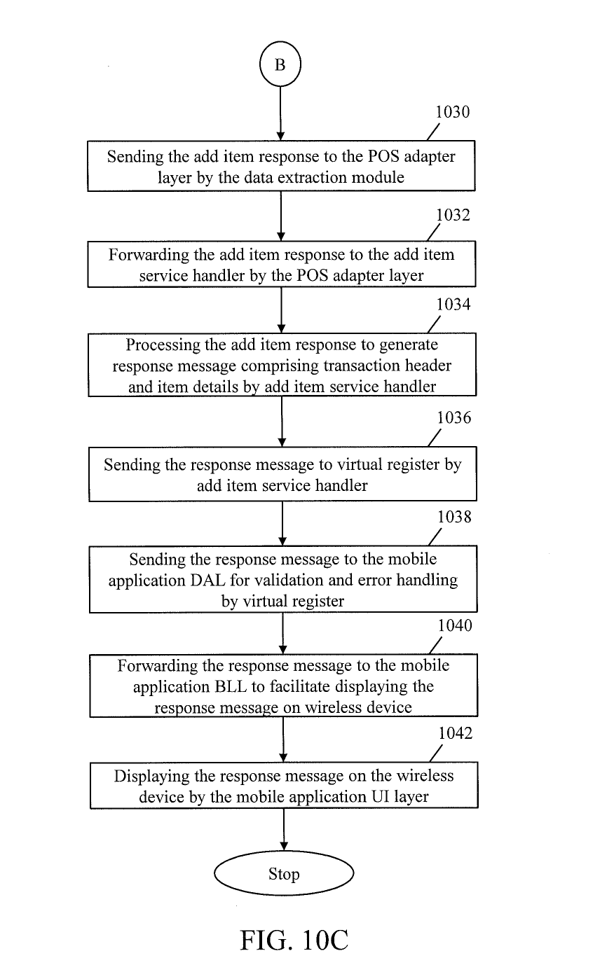

FIG. 10A, FIG. 10B, and FIG. 10C is a flowchart illustrating an ‘add item’ data flow using a wireless device integrated to an existing POS system in accordance with an embodiment of the present invention.

At step 1002, a user accesses the MPOS device application on the wireless device. The MPOS device application provides an interface to the user to perform various POS tasks such as, but not limited to, user authentication, barcode scanning, manually entering product code, product lookup, cash tendering, void cash tendering, add item, void item, void transaction, card tendering support, Magnetic Strip Reader (MSR) support, capturing signature, void card tendering (gift/debit/credit), Customer Relationship Management (CRM) system integration, chip and pin card reader support, receipt based recall, internationalization support such as supporting multiple languages; multiple currencies; date and time format, inter store lookup for product availability, 3^{rd} party card balance inquiry, printing receipt, voiding, retrieving and/or suspending transactions, accepting electronic signatures, customer data acquisition, e-mailing receipt, issuing gift cards, handling gift card inquiry, etc. using the MPOS device application. In an embodiment of the present invention, the user includes, but not limited to, sales assistants, sales executives, sales personnel, store keepers, employees, etc.

In various embodiments of the present invention, the interface provided by the MPOS device application may include, but not limited to, graphical user interface, character user interface, web based user interface, etc. Further, the interface provides various options to facilitate performing one or more POS tasks.

At step 1004, the user selects ‘add item’ option from the various options provided by the mobile application UI layer of the MPOS device application on the wireless device to add an item to the transaction list. In various exemplary embodiments of the present invention, the user may select one or more options from the various options provided by mobile application UI layer such as, but not limited to, barcode scanning, product/price lookup, suspend, resume, cash tendering, employee login/logoff, add item, void item, credit card tendering, gift card tendering, void credit/gift card tender, MSR support, E-receipt, encryption support, register open/close, training mode support, receipt printing, transaction level discount, gift receipt tendering, price modify, void after, add/remove fee code, employee discount, suspend receipt, gift card balance inquiry, 3^{rd} party gift card balance inquiry, gift card, receipt recall, etc. to perform a particular POS task.

At step 1006, the mobile application UI layer facilitates sending the add item request along with the product identifier such as, but not limited to, Universal Product Code (UPC), European Article Number (EAN), etc. to the mobile application BLL of the MPOS device application. In various embodiments of the present invention, the mobile application UI layer facilitates sending the service request to the mobile application BLL to perform a particular task related to the option selected by the user.

At step 1008, the mobile application BLL processes the add item request to generate Trans ID and User ID. Further, the Trans ID and User ID facilitate identification of the transaction and identification of the user respectively. In various embodiments of the present invention, the mobile application BLL facilitates processing the one or more service requests by applying one or more business rules and logic related to the received one or more service requests.

At step 1010, the mobile application BLL facilitates sending the processed add item request to the mobile application DAL of the MPOS device application. The processed add item request comprises product identifier, Trans ID, and User ID. In various embodiments of the present invention, the mobile application BLL facilitates sending the one or more processed service requests related to a particular POS task to the mobile application DAL.

At step 1012, the mobile application DAL facilitates combining the Device ID to the processed add item service request. The Device ID facilitates identification of the wireless device. The mobile application DAL facilitates extraction of data pertaining to Device IDs. In various exemplary embodiments of the present invention, the mobile application DAL facilitates combining the Device ID to the processed service request to facilitate identification of the wireless device generating the service request.

At step 1014, the mobile application DAL facilitates sending the processed add item request with corresponding product identifier, Trans ID, User ID and Device ID to service infrastructure layer. The service infrastructure layer facilitates interfacing the wireless devices with appropriate virtual register module. In various embodiments of the present invention, the service infrastructure layer interfaces each wireless device to a particular virtual register that handles its one or more service requests.

At step 1016, the service infrastructure layer facilitates dispatching the add item request with corresponding product identifier, Trans ID, User ID and Device ID to appropriate virtual register. At step 1018, the service infrastructure layer facilitates forwarding the add item service request with corresponding product identifier, User ID, and Trans ID to the add item service handler. In various embodiments of the present invention, the virtual register dispatches the service request to appropriate service handler related to the received service request. In an embodiment of the present invention, the virtual register dispatches void item service request to a void item service handler. In another embodiment of the present invention, start transaction service request is dispatched to start transaction service handler.

At step 1020, the add item service handler prompts the command generator module residing in the POS adapter layer to generate add item commands corresponding to the forwarded product identifier, User ID, and Trans ID. In various embodiments of the present invention, the service handler ensures that the command generator module generates commands pertaining to the received service request.

At step 1022, the command generator module generates add item commands pertaining to the received add item service request. In various embodiments of the present invention, the command generator module generates commands pertaining to the received service request. In an embodiment of the present invention, the command generator module may generate void item commands to facilitate removing an item from transaction list. In another embodiment of the present invention, the command generator module generates start transaction commands to facilitate a POS transaction.

At step 1024, the command execution module executes the add item commands. In various embodiments of the present invention, the command execution module facilitates execution of commands to perform the requisite POS task by the business logic layer components existing in the ACR POS module.

At step 1026, the business logic layer components of the ACR POS module facilitates processing of the add item command to add an item to the transaction list by generating an add item response. In various embodiments of the present invention, the business logic layer components apply existing business rules and logic and communicate with the store server to perform the requisite POS task. In an embodiment of the present invention, the business logic layer components may facilitate verifying the employee by processing the employee login command.

At step 1028, the data extraction module facilitates extracting the add item response from the data structures of the ACR POS module.

At step 1030, the data extraction module sends the add item response to the POS adapter layer that facilitates interfacing the wireless device to the ACR POS module. In various embodiments of the present invention, the service request response is sent to the POS adapter layer to be communicated back to the wireless device.

At step 1032, the add item response is forwarded to the add item service handler by the POS adapter layer. At step 1034, the add item service handler processes the add item response to generate appropriate response message comprising transaction header and item details. The transaction header comprises the device identification, user identification, and transaction identification details. The item details comprises the item related details such as, item code, item price, item description, etc.

At step 1036, the add item service handler sends the response message comprising transaction header and item details to the virtual register. At step 1038, the response message is sent to mobile application DAL of the MPOS device application. The mobile application DAL facilitates validation and error handling of the received response message. In various embodiments of the present invention, the response message is sent to mobile application DAL of the MPOS device application for validation and error handling.

At step 1040, the mobile application DAL facilitates forwarding of the response message to the mobile application BLL which communicates with the mobile application UI layer to facilitate displaying the response message on the wireless device. At step 1042, the mobile application UI layer facilitates displaying response message on the wireless device.

The present invention may be implemented in numerous ways including as an apparatus, method, or a computer program product such as a computer readable storage medium or a computer network wherein programming instructions are communicated from a remote location.

Various embodiments of the present invention, may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A method for extending point of sale functionalities of an existing point of sale system, the method comprising the steps of:
building at least one Abstracted Core Register Point of Sale (ACR POS) module from at least one existing point of sale register application;
optimizing at least one ACR POS module for extending point of sale functionality to at least one wireless device;
mapping at least one wireless device to at least one virtual register module and at least one optimized ACR POS module to extend the point of sale functionalities of the existing point of sale system to the mapped wireless device; and
performing one or more point of sale tasks using the mapped wireless device.

2. The method of claim 1, wherein the step of building at least one ACR POS module from at least one existing point of sale register application comprises:
de-activating one or more peripheral devices and their interaction with the existing point of sale register application;
de-activating user interface dependencies from the existing point of sale register application;
building a command execution module for the existing point of sale register application; and
building a data extraction module for the existing point of sale register application.

3. The method of claim 1, wherein the step of optimizing at least one ACR POS module for extending point of sale functionality to at least one wireless device is facilitated by performing memory and performance optimization, wherein the memory and performance optimization methodology at least comprises: pre-initializing components, eliminating threads and modules which are required for updating the user interface and peripheral interactions, dynamic reloading of the ACR POS module components, restricting loading of the existing POS system specific components which are not required for extending POS functionality to wireless device, and any other suitable optimizing methodology.

4. The method of claim 1, wherein the step of optimizing at least one ACR POS module is facilitated by using multi instance execution model, wherein the multi instance execution model at least comprises: multi-process execution model, multi-thread execution model and any other suitable multi instance execution model.

5. The method of claim 1, wherein the step of mapping at least one wireless device to at least one virtual register module and at least one optimized ACR POS module to extend the point of sale functionalities of the existing point of sale system to the mapped wireless device comprises:
creating a mapping node corresponding to at least one wireless device;
mapping at least one virtual register module to the mapping node; and
mapping at least one optimized ACR POS module to the mapping node.

6. The method of claim 1, wherein the step of performing one or more point of sale tasks using the mapped wireless device comprises:
receiving a service request from the mapped wireless device by a mobile point of sale server;
generating one or more commands using parameters received from service request, wherein a virtual register facilitates generating one or more commands using a point of sale adapter layer;
sending the one or more commands to the mapped ACR POS module;
processing the one or more commands by existing business logic layer components residing in the mapped ACR POS module to generate a response;
transmitting the response to the mapped virtual register module;
processing the response by the mapped virtual register module to generate a message; and
transmitting the message to the mapped wireless device.

7. The method of claim 1, wherein the one or more point of sale tasks may at least comprise: barcode scanning, cash tendering, generating receipt, printing receipt, canceling transactions, retrieving transactions, suspending transactions, accepting electronic signatures, e-mailing receipt, viewing transaction history, viewing offers and schemes, issuing gift cards, handling gift card inquiries, accepting credit/debit/gift cards, or any other point of sale task.

8. A system for extending point of sale functionalities of an existing point of sale system, the system comprising:
one or more wireless devices configured to generate one or more service requests to perform one or more point of sale tasks, wherein each wireless device further comprises a mobile point of sale device application; and
a mobile point of sale server configured to integrate the one or more wireless devices with the existing point of sale system, wherein the mobile point of sale server further comprises:
one or more virtual register modules configured to generate one or more commands pertaining to the one or more service requests and further configured to send the generated one or more commands to at least one Abstracted Core Register Point of Sale (ACR POS) module; and
one or more ACR POS module configured to facilitate processing the one or more commands pertaining to the one or more service requests using business logic layer components of an existing point of sale register application of the existing point of sale system;
wherein at least one wireless device is mapped with at least one virtual register module and at least one ACR POS module.

9. The system of claim 8, wherein the mobile point of sale server further comprises:
a service infrastructure layer configured to interface at least one wireless device to the mapped at least one virtual register module and further configured to dispatch the one or more service requests from the at least one wireless device to the mapped at least one virtual register module;

10. The system of claim 8, wherein the one or more virtual register modules further comprises:
a virtual register configured to handle one or more service requests and further configured to facilitate generating one or more commands pertaining to the received one or more service requests from the at least one wireless device;
a service handling layer comprising one or more service handlers configured to facilitate servicing one or more functionalities pertaining to the received one or more service requests; and
a point of sale adapter layer configured to generate one or more commands pertaining to the received one or more service requests and further configured to send the generated one or more commands to the mapped at least one ACR POS module.

11. The system of claim 8, wherein the ACR POS module further comprises:
a command execution module configured to facilitate execution of one or more commands pertaining to the one or more service requests;
business logic layer components configured to facilitate processing of the executed one or more commands;
data access layer components configured to access data from a store server database to facilitate processing of the executed one or more commands; and
a data extraction module configured to facilitate extracting updated data pertaining to the processed one or more commands.

12. The system of claim 8, further comprising:
a network configured to connect the one or more wireless devices to the mobile point of sale server.

13. The system of claim 8, wherein the mobile point of sale device application comprises: a mobile application user interface layer, a device peripheral abstraction layer, a mobile application business logic layer, and a mobile application data access layer.
